(19) United States
(12) Patent Application Publication
(10) Pub. No.: US 2025/0324969 A1
(43) Pub. Date: Oct. 23, 2025

(54) PESTICIDE SYNERGIST SX-PYR

(71) Applicants: Denis Mbonimpa, Brussel (BE); Carlo Jeunen, Sint-Truiden (BE)

(72) Inventor: Denis Mbonimpa, Brussel (BE)

(21) Appl. No.: 17/766,425

(22) PCT Filed: Oct. 5, 2020
(86) PCT No.: PCT/EP2020/077885

§ 371 Date: Oct. 14, 2024

(30) Foreign Application Priority Data
Oct. 5, 2019 (BE) BE2019/5655

(51) Int. Cl. A01N 37/08; A01N 31/16; A01N 65/12; A01N 65/30; A01P 17/00

(52) U.S. Cl. CPC A01N 37/08; A01N 31/16; A01N 65/12; A01N 65/30; A01P 17/00

(57) ABSTRACT

The present invention relates to a composition and to the production and use of said composition.

Pesticide synergist composition containing, among others, (1) a cysteine proteolytic enzyme (or a mixture of cysteine proteolytic enzymes), (2) a polyphenolic compound (or a mixture of polyphenolic compounds chosen from among hydrolysable tannins), (3) a compound chosen from among the triglycerides (or a mixture thereof), (4) a phase change inhibitor chosen from among (ethanol, isopropyl alcohol, benzylic alcohol and the mixtures thereof), (5) an enzyme stabilizer chosen from among the organic peroxides, (6) a non-ionic surfactant, (7) an essential oil chosen from among the essential oils of Melaleuca alternifolia and quinquenervia, (9) a simple reagent such as acetic acid and citric acid to modify/stabilize the pH the present invention may be in the form of a concentrate or an emulsion containing pyrethrins (pyrethrum flower extract), pyrethroids (i) and (ii), and a mixture thereof. said composition is intended for use in managing the resistance associated with the mechanisms of insects for detoxifying insecticides and to improve the efficiency of certain insecticides, in particular certain insecticides such as pyrethrins and pyrethroids (i) and (ii).

The present invention relates to a composition and to the production and use of said composition.

The invention relates to a formulation characterized by the simultaneous presence of supramolecular complexes based on pyrethrins, pyrethroids (I) and (II), and a pesticide synergist, in particular pyrethrins and pyrethroids (I) and (II). One of the two components has an insecticidal, acaricidal, fungicidal, or vermicidal activity, whereas the other component has a synergist activity when it is associated with the first components, and reinforces its efficiency. The active ingredient is chosen from among the pyrethroids (I) and (II), wherein are present atoms of hydrogen 1, 2 or 3. The synergist substance is in the form of a composition of fatty, saturated, monounsaturated, and polyunsaturated acids associated with a cysteine protease, for example papain associated with a polyphenolic composition comprising hydrolysable tannins (or gallic or ellagic tannins) and flavonoids, such as flavanols, for instance quercetin (C15H10O7) On the one hand, these new compositions improve the action of certain insecticides such as (natural pyrethrum and pyrethroids) and, on the other hand, have an inhibiting activity, on certain genes in resistant mosquitoes. These same genes code for “biodegradation enzymes”: proteins that enable inactivation of toxic substances, i.e., pesticides, thereby rendering mosquitoes and certain pests insecticide resistant. This composition is associated with a phenol derivative such as: 1,3-(methylenedioxy)phenol, 5-hydroxy-1,3-benzodioxole, comprising at least one aromatic or non-aromatic carbocyclic ring. The invention also relates to a method for preparing said formulation and its use in the activities described above. One of the characteristics that is distinctive, identified, and contributive to a surprising technical effect is the involvement in the present invention of a polyphenol of the family of tannins associated with an identified and innovating molecule in this application, whereas usually polyphenols of the family of tannins are only soluble in water, ethanol, acetone, and methyl alcohol. Among the components of the synergist, this composition is involved in the process of protecting the pyrethrins and pyrethroids (I) and (II) against their detoxification by insects.

### CONTEXT OF THE INVENTION

The invention relates to a formulation characterized in that it is a synergist of pyrethrins and pyrethroids, and consequently the invention is also characterized by the simultaneous presence of supramolecular complexes that are based on pyrethrins, pyrethroids (I), and the synergist of the present invention. One of the two components has an insecticidal, acaricidal, fungicidal, or vermicidal activity, whereas the other component has a synergist activity when it is associated with the first component, and reinforces its efficiency. The biologically active ingredient is chosen from among the following classes of chemical products: in addition, at least one certified pyrethroid is chosen from among the group comprising: pyrethrins and pyrethroids (I) and (II), described as follows: permethrin, deltamethrin, tetramethrin, cypermethrin, and different mixtures of isomers derived therefrom, in particular α-cypermethrin, asymethrin, esbiothrin, kadethrin, acrinathrin, cyhalothrin, and the different mixtures of isomers derived therefrom, and in particular λ-cyhalothrin, cyfluthrin, tralomethrin, fluvalinate, fenvalerate, S-fenvalerate, or (1R,cis) 2,2-dimethyl 3-[(Z) 2-(methoxycarbonyl) ethynyl] cyclopropane carboxylate of(S) α-cyano 3-phenoxybenzyle However, the pyrethroids in which atoms of hydrogen 1, 2, or 3 are present.

The synergist ingredient is in the form of a composition of fatty, saturated, monounsaturated and polyunsaturated acids, chosen from among short-chain fatty acids, C(6:O), C(8:O), C(10:O), C(12:O), C(14:O), medium-chain fatty acids, C(16:Ow9), C(17:O), C(18:O), C(18:1w9), C(18:1w7), C(18:2LA), and long-chain fatty acids, C(20:0), C(20:1w11), C(20:1w9), C(24:O), characterized in that it is associated with a cysteine protease and a polyphyletic composition comprising hydrolysable tannins (or gallic or ellagic tannins) and flavonoids, such as flavanols, for instance quercetin (C15H10O7). On the one hand, these new compositions improve the action of certain insecticides such as (natural pyrethrum and pyrethroids) and, on the other hand, have an inhibiting activity, on certain insecticides such as (natural pyrethrum and pyrethroids) and also have an inhibiting activity on certain genes found in resistant mosquitoes. These same genes code for biodegradation enzymes of proteins that enable inactivation of toxic substances, thereby rendering mosquitoes and certain pests insecticide resistant. This composition is associated with a phenol derivative such as: 1,3-(methylenedioxy)phenol, 5-hydroxy-1,3-benzodioxole, with a stabilizing effect on proteolytic enzymes, containing at least one aromatic or non-aromatic carbocyclic ring.

The synergist ingredient has a composition of fatty, saturated, monounsaturated and polyunsaturated acids, chosen from among short-chain fatty acids, C(6:O), C(8:O), C(10:O), C(12:O), C(14:O), medium-chain fatty acids, C(16:Ow9), C(17:O), C(18:O), C(18:1w9), C(18:1w7), (C18:2LA), C(18:3), and long-chain fatty acids, C(20:0), C(20:1w11), (C20:1w9), C(20:4), C(24:O).

The present invention relates to a new synergist composition of pesticides containing, as active ingredient, a proteolytic enzyme, i.e. a cysteine protease, and a polyphenolic composition or a mixture of polyphenolic compositions constituted of hydrolysable tannins (gallic or ellagic tannins) or flavonoids, such as flavanols, for instance quercetin, and possibly comprising a triglyceride or a mixture of triglycerides, for example (sesame, cotton, coconut, paraffin, sunflower, soybean, canola, or corn oil, preferably methylated sesame, cotton or canola oil) associated with a phase change inhibitor chosen from among ethanol, isopropyl alcohol, benzyl alcohol, and the mixture thereof; and a protein stabilizer, preferably hydrogen peroxide.

The present invention is characterized by one of the compositions that enable quick penetration of the insecticide into the nervous system of pests, owing to the simultaneous presence of short-chain fatty acids, featuring for instance a combination of fatty acids such as: C(6:6), C(8:O), C(10:O), C(12:O), C(14:O).

The present invention is also characterized by its antioxidant role with respect to insecticides, thereby prolonging the remanence of pyrethrins and pyrethroids (I) and (II) by the action of one of its medium-chain fatty acid components, which include, for instance, C(16:1w9), C(16:1cisw7).

This composition is also antioxidant, and it intervenes at the initiation stage. In vivo, the oxygenases (enzymes that enable oxidation), such as lipoxygenase and cyclooxygenase enable the synthesis of eicosanoids, leukotrienes for the first, prostaglandins for the second, from arachidonic acid C(20:4) and C(18:3).

The synergist of the present invention intervenes in the process of combating the detoxification of pyrethrins and pyrethroids (I) and (II) by the insects.

Mosquitoes and insect pests that harm crops and are resistant to insecticides participate in an increased production of detoxification enzymes: “The esterases are enzymes naturally produced by all mosquitoes: they degrade organophosphorus insecticides; they are biodegradation enzymes”. The insects generally produce proteins that enable inactivation of toxic substances, even after a treatment, and presumed-dead insects are sometimes reanimated by their enzymes that continue to detoxify the ingested insecticides.

The present invention acts against tolerance phenomena by these pests (insects) and in particular mosquitoes resistant to pyrethroids by its action associated with the presence of long-chain fatty acids, among which feature two isomers such as: C(20:1w11), C(20:1w9). The action they generate accelerates the speed of action of the insecticide by rapidly reaching the target, in this case the synaptic space. It must therefore rapidly penetrate the organism of the insect and circulate within its internal environment. The compositions of the invention are characterized in that they prevent the esterases produced by the mosquitoes from trapping or metabolizing the insecticides before they are able to inhibit the acetylcholinesterase (ACE) in the synapses.

The differences in the properties of the ACE (acetylcholinesterase) between mosquitoes that have this form of resistance and sensitive mosquitoes can be detected using the following test:
Experimental protocol TESTS No.-1: Sensitive and resistant mosquitoes. Tested product: the insecticide Propoxur (Baygon).
Experimental protocol TESTS No.-2: Sensitive and resistant mosquitoes. Tested product: Insecticide -NILO-PYR, the composition of which contains: 2.5 g/L of pyrethrins and 12.5 g/L of the “SYNERGIST OF THE COMPOSITION OF THE PRESENT INVENTION-SX-PYR”.

1° the mosquito (or larva) is crushed and the crushed material is homogenized in an Eppendorf tube with a buffer solution (20 mM tris, pH 7, containing 1% of Triton X-100). After centrifugation at 10,000 g for 2 minutes, the supernatant (which contains the ACE) is collected and distributed in the wells (A) and (B) of a microplate (100 microliters in each well),

2° in each well is then added either 10 microliters of a concentrated solution of insecticide (pyrethrum-based products at 10-2 M), Baygon, a brand of pesticides produced by S. C. Johnson in well (B), and 10 microliters of alcohol, in well (A). The microplate is left for 15 min at ambient temperature (which is sufficient to allow the action, if any, of the insecticide),

3°determination of the catalytic activity of the ACE (acetylcholinesterase): in each well is added 100 microliters of a solution containing acetylcholine (2.5 mM) and 0.2 mM of DTNB (dinitro-2-benzoic). The intensity of the coloration is assessed by measuring the optical density (the optical density increases based on the coloration) If the enzyme is active, the products of the hydrolysis of the acetylcholine react with the DTNB to produce a substance that features an absorption peak for the radiations of 412 nm. It is therefore possible to follow the reaction by spectrophotometry.

### Experimental Protocol TESTS No.-1: Sensitive and Resistant Mosquitoes TESTED Product: The Insecticide Propoxur (Baygon).

The below graphs in FIG. 6 show the evolution of the optical density over 10 min in each well, for 8 sensitive mosquitoes and 8 resistant mosquitoes (y-axis: intensity of the optical density; x-axis: time)

### Observations:

### Sensitive Subjects

The production of esterases by sensitive mosquitoes is very low and insufficient to prevent the Propoxur insecticide (Baygon) from working.

### Resistant Subjects

Observations: the analysis of results for resistant mosquitoes: the slope of the curves showing the evolution of the optical density is practically the same in the wells with or without insecticide. It is therefore possible to conclude that the ACE of resistant mosquitoes is completely resistant to the Propoxur (Baygon) insecticide.

Furthermore, the slope of the curve showing the evolution of the optical density in the absence of insecticide is significantly lower in resistant mosquitoes than in sensitive mosquitoes. The ACE of resistant mosquitoes is therefore less active and less effective than that of sensitive mosquitoes. The reduction in the resistant enzyme's activity compared with the sensitive enzyme is approximately 60%. This is an aspect of the resistance cost.

Experimental protocol TESTS No.°-2: Sensitive and resistant mosquitoes TESTED Product -NILO-PYR, the composition of which contains: 2.5 g/L of pyrethrins and 12.5 g/L of the “SYNERGIST OF THE PRESENT INVENTION-SX-PYR”.

Observations in FIG. 7: The analysis of results for resistant and sensitive mosquitoes: with respect to the control wells (A), the evolution of the optical density of the wells wherein the insecticide (B) NILO-PYR was added is almost nil (horizontal line). The ACE has therefore been inactivated by the NILO-PYR insecticide.

The compositions of this invention enable inhibition of the over-production of detoxifying enzymes produced by resistant mosquitoes. (Illustration in FIG. 7—Test No.2)

The present invention is characterized by its ability to provoke, at very low doses, the dissociation of a significant quantity of esterases produced by the insects, and more particularly by resistant mosquitoes. The compositions of the present invention disrupt the increased production of esterases in resistant insects and makes the target acetylcholinesterase (ACE) more sensitive to the insecticide. The esterases are enzymes naturally produced by insects: they hydrolyze the ester bonds, in particular those of the molecules of organophosphate insecticides.

The compositions of the invention are characterized by the action of preventing the esterases produced by the mosquitoes from trapping or metabolizing the insecticides, before they are able to inhibit the acetylcholinesterase (ACE) in the synapses.

The compositions of the invention enable the insecticide to penetrate the organism of the resistant mosquito and to circulate within its internal environment, to cause its nervous system to malfunction, and to act on the target, the acetylcholinesterase enzyme (ACE, present at the level of the cholinergic synapses and responsible for hydrolyzing the acetylcholine neurotransmitter).

Synergists are chemical products that do not have a pesticide effect but that improve the pesticide properties of other chemical products. Piperonyl butoxide (PBO) is defined as a synergist used in many pesticides. Piperonyl butoxide (PBO) can be added to phytosanitary formulations that contain pyrethrins or more generally compounds of the pyrethroid family. After ingestion by the insects, the PBO inhibits the secretion of certain enzymes, and potentiates the insecticidal properties of the phytosanitary product. The PBO has harmful effects on the human endocrine system and on the environment. Currently, the analyses and results of Casdar Sécurbio show that piperonyl butoxide, when used as a synergist of insecticides (natural pyrethrum, and synthetic pyrethroids), is present in plant (cereals) and animal (meat) productions in the form of residue (intact substance). It is not a phytosanitary product but is considered under articles 25 and 26 of Regulation (EC) No 1107/2009 and was not, in this regard, subject to a maximum residue level (MRL). Products that contain piperonyl butoxide (PBO) The CNAB in France, on the 8th of November 2015, decided to ban the use of all products containing PBO in organic farming, within the following timeframes: Removal of the AB mention on the labels of affected products intended for sale and distribution as from the 31st of March 2017. End of use of the stock by the 30th of September 2017. Products containing PBO will be removed from the guide as from the 30th of September 2017. Products containing PBO are marked by an asterisk in the guide.

Synergist products have been described in Patent WO 2011154434 A2, Pesticide Mixtures comprising isooxazoline derivatives and in the Patent:
WO2007101547A2*21 Feb. 2007 13 Sep. 2007 Bayer Cropscience Ag Synergic combinations of active ingredients

In the article by Corbel et al., “Dinotefuran: Un insecticide nicotinique potentiel contre les moustiques résistants” published in J. Med. Entomol. 41 (4): 712.717 (2004), Dinotefuran was proposed as an insecticidal agent for mosquito nets. In this article, it was shown that Dinotefuran had a lethal effect on mosquitoes of the Anopheles gambiae, Aedes aegypti and Culex quinquefasciatus species. Dinotefuran has also been shown to have a lethal effect on the VKPR mosquito strain (also called VKPER) of the Anopheles gambiae species, which has a mutation for knockdown resistance to pyrethroids.

Resistance to neonicotinoids is relatively widespread among target populations of crop pests. In Spain, resistance to Imidacloprid in the silverleaf whitefly was discovered in 1996; in the United-States, the Colorado potato beetle, which is harmful to potato crops, has been showing a resistance to the same insecticide since 1997 (Millar and Denholm, 2007). Luckily, neonicotinoids have only been used experimentally in mosquitoes, which limits their impact on the selection of resistance in these vectors.

The chemical substance is rendered wholly ineffective, which generates real problems, be it in farming or in vector control, as there is no longer any means to regulate the pest population. Today, resistances have been observed in most disease vector species around the world. (Carnevale et Robert, 2009).

Mosquitoes and insect pests that harm crops and are resistant to insecticides participate in an increased production of detoxification enzymes: “The esterases are enzymes naturally produced by all mosquitoes: they degrade organophosphorus insecticides; they are biodegradation enzymes”. The insects generally produce proteins that enable inactivation of toxic substances, even after a treatment, and presumed-dead insects are sometimes reanimated by their enzymes that continue to detoxify the ingested insecticides.

However, for an insecticide to be effective, it must be able to reach its target, in this case the synaptic space. It must therefore penetrate the organism of the insect and circulate within its internal environment. Resistance to organophosphate insecticides and to carbamates can therefore be explained by mechanisms that prevent insecticides from reaching their target, or by a reduced sensitivity of the target (ACE).

Prior research details the activity of the pancreas, which produces proteolytic enzymes, mainly trypsin and chymotrypsin, which are essential to the proper digestion of proteins. Certain plants contain similar enzymes, which are also able to break down protein molecules. This is the case, for example, with papain, which comes from the papaya (Carica papaya, Caricaceae family), and with bromelain which is derived from pineapple (Ananas comosus, Bromeliaceae family). Regardless of whether they come from an animal or a plant source, all proteolytic enzymes participate in the protein digestion process.

The compositions of the invention comprise at least one natural substance, sulfhydryl protease (RS-H), which comes from latex and papaya and is part of the Peptidase C1 family: “papain”. Papain is composed of a single polypeptide chain with three disulfide bridges, affording it good stability And a group required for the activity of the sulfhydryl enzyme, the polypeptide chain is also formed of 212 amino acid residues. This chain is folded in two groups, an inactive part and an active part, the latter being represented by oxidized sulfhydryl groups, mainly present in CYS 25. The alpha helix has a C═O bond directed towards the axis of the helix, whereas the hydrogens are in antiparallel conformation, and are directed towards the nuclei of the sheets. It therefore has an active-site cysteine nucleophile at position 25 that attacks the peptide bond. Structure of papain and shown in FIG. 1, a cysteine protease.

### Physical and Kinetic Properties

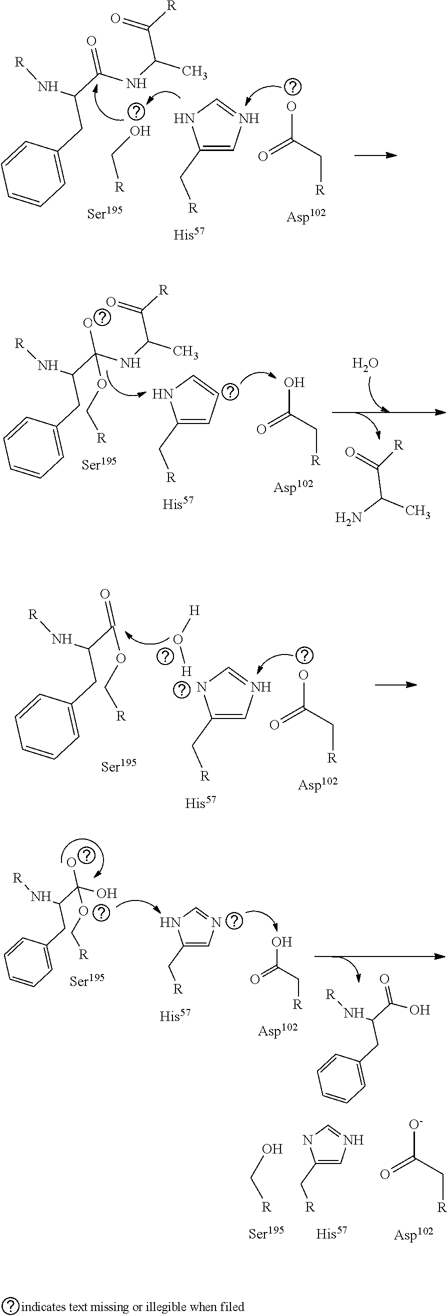

### SUMMARY OF THE INVENTION

The present invention relates to a synergist composition of pesticides containing, as active ingredient, (1) a proteolytic enzyme, or a mixture of proteolytic enzymes, preferably cysteine proteases, (2) and a polyphenolic composition chosen from among hydrolysable tannins (or gallic or ellagic tannins) and flavonoids, such as flavanols, for instance quercetin, (3) and a triglyceride chosen from among methylated sesame, cotton, coconut, paraffin, sunflower, soybean, canola, or corn oil, (4) a phase change inhibitor chosen from among ethanol, isopropyl alcohol, benzyl alcohol, and the mixture thereof; (5) a protein stabilizer, for instance hydrogen peroxide, (6) a non-ionic surfactant, for instance coco glucoside; (7) an essential oil chosen from among the essential oils of Melaleuca alternifolia and quinquenervia, (8) a simple reagent such as acetic acid and citric acid to modify/stabilize the pH of the composition of the invention. The said composition is intended to be used for the management of resistance associated with the mechanisms of insects that detoxify the insecticides and the improvement of pesticides and some insecticides, such as (natural pyrethrum and the pyrethroids (I) and (II)). One of the reasons for the emergence of resistance is associated with the overproduction of detoxifying enzymes by certain insects; by halting this overproduction, the present invention enables the multiplication of resistant strains to be limited and its use generates human health benefits through formulations that feature a lower active ingredient concentration, and therefore more favorable toxicological ratings; by reducing the quantity of insecticides necessary, it is possible to reduce the levels of insecticide residues in treated stored grains. The present invention relates to a pesticide synergist composition that can further be in the form of a concentrate or an emulsion that contains pyrethrins (pyrethrum flower extract), pyrethroids (I) and (II), and a mixture thereof.

The compositions of the present invention have been the subject of research focusing on the action of hydrolysable tannins, which are plant substances belonging to the polyphenol family; they are of plant origin and have the ability to precipitate proteins.

The present invention is a composition that associates, among others, a proteolytic enzyme (papain) and a polyphenolic compound (tannic acid).

1. Synergist composition of pyrethrins and pyrethroids (I) and (II) featuring a composition of fatty, saturated, monounsaturated and polyunsaturated acids, chosen from among short-chain fatty acids, C(6:O), C(8:O), C(10:O), C(12:O), C(14:O), medium-chain fatty acids, C(16:Ow9), C(17:O), C(18:O), C(18:1w9), C(18:1w7), C(18:2LA), and long-chain fatty acids, C(20:0), C(20:1w11), C(20:1w9), C(24:O), characterized in that it is associated with a cysteine protease and a polyphenolic composition or a mixture of polyphenolic compounds composed of hydrolysable tannins or gallic or ellagic tannins and flavonoids, such as flavanols, for instance quercetin (C15H10O7). On the one hand, these new compositions improve the action of certain insecticides such as (natural pyrethrum and pyrethroids) and, on the other hand, have an inhibiting activity, on certain insecticides such as (natural pyrethrum and pyrethroids) and also have an inhibiting activity on certain genes found in resistant mosquitoes. These same genes code for biodegradation enzymes of proteins that enable inactivation of toxic substances, thereby rendering mosquitoes and certain pests insecticide resistant. This composition is associated with a phenol derivative such as: 1,3-(methylenedioxy)phenol, 5-hydroxy-1,3-benzodioxole, with a stabilizing effect on proteolytic enzymes, containing at least one aromatic or non-aromatic carbocyclic ring.

2. Composition according to claim 1, characterized in that said cysteine protease is chosen from among fig tree ficin, papaya papain, pineapple bromelain, protease from Asclepias (Asclepias speciosa), protease from Euphorbia (E. cerifera), solanine (S. Eleagnifoldium), pomirin (Maclura pomifera) and mexicain (Pileus mexicanus).

3. Composition according to the previous claim, characterized in that said cysteine protease chosen is papain.

4. Composition according to any one of the previous claims, characterized in that the cysteine protease is present in a proportion ranging from 1 to 90%, in weight, with respect to the total weight of the composition.

5. Composition according to any one of the previous claims, characterized in that the cysteine protease is present in a proportion ranging from 1 to 10%, in weight, with respect to the total weight of the composition.

6. Composition according to any one of the previous claims, characterized in that said polyphenolic compound is chosen from among flavonoids, carnosic acid, carnosol, substituted (2,5-dihydroxyphenyl) carboxylic (2,5-dihydroxy phenyl) allylenes carboxylic acids, and the derivatives thereof, esters or amides of caffeic acid and tannic acid.

7. Composition according to claim 1, characterized in that said selected polyphenolic compound is tannic acid.

8. Composition according to any one of the previous claims, characterized in that the polyphenolic compound is present in a proportion ranging from 1 to 10%, in weight, with respect to the total weight of the composition.

9. Composition according to any one of the previous claims, characterized in that the polyphenolic compound is present in a proportion ranging from 0.1 to 1%, in weight, with respect to the total weight of the composition.

10. Composition according to any one of the previous claims, characterized in that the composition contains a triglyceride chosen from among (sesame, cotton, coconut, paraffin, sunflower, soybean, canola or corn oil, preferably methylated sesame, cotton or canola oil).

11. Composition according to any one of the previous claims, characterized in that the said triglyceride chosen is sesame oil.

12. Composition according to the previous claims, characterized in that it contains 0.1 to 800 g/L of fatty acids, C(6:O), C(8:O), C(10:O), C(12:O), C(14:O), medium-chain fatty acids, C(16:Ow9), C(17:O), C(18:O), C(18:1w9), C(18:1w7), C(18:2LA), C(18:3) and long-chain fatty acids, C(20:0), C(20:1w11), C(20:1w9), C(24:O), C(24:O), associated with 0.1 to 100 g of tannic acid and 1 to 250 g of (+)-4-Isopropenyl-1-methylcyclohexene, (+)-Isopropenyl-4 methyl-1 cyclohexene, D-Isopropenyl-4 methyl-1 cyclohexene, (D)-Limonene and, in addition, the present compositions can contain 0.1 to 10 g/L of citric acid, and 0.1 to 10 g/L of acetic acid.

13. Composition according to claim 1, characterized in its use as a synergist of pesticides in combination with pyrethroids such as: permethrin, bifenthrin, deltamethrin, tefluthrin, tetramethrin, cypermethrin, and different mixtures of isomers derived therefrom, in particular α-cypermethrin, asymethrin, esbiothrin, kadethrin, acrinathrin, cyhalothrin, and the different mixtures of isomers derived therefrom, and in particular λ-cyhalothrin, cyfluthrin, tralomethrin, fluvalinate, fenvalerate, s-fenvalerate, or (1R,cis) 2,2-dimethyl 3-[(Z) 2-(methoxycarbonyl) ethynyl] cyclopropane carboxylate of (S) α-cyano 3-phenoxybenzyle.

14. The compositions according to the previous claims are used in combination with pesticides, in the amount of 0.1 to 900 g/L of the composition according to the previous claims, preferably 30 to 45 g/L of the composition according to the previous claims, in a composition containing 1 to 900 g/L of deltamethrin, preferably from 1 to 15 g/L of deltamethrin.

15. The compositions according to the previous claims are used diluted in water and are applied using a sprayer; it is, for example, possible to dilute 100 ml of this composition in 5 liters of water. It is therefore possible to effectively treat 100 m2 of surface area (treatment against crawling insects). When treating surface areas against flying insects, 65 ml of the composition described above can be diluted in 5 liters of water. When treatments via nebulization are required, it is possible to dilute 700 ml of the above compositions in 9 liters of a petroleum solvent and apply the obtained solution in the amount of 500 ml of solution per hectare. When indoor spaces are to be treated, it is possible to dilute 500 ml to 1000 ml of the above composition in 4 liters of a petroleum solvent and apply 250 ml of the obtained solution to treat 1000 m3 of indoor space.

16. The compositions according to the previous claims are used in combination with pesticides; for example, a combination in the amounts of 0.1 to 900 g/L of the final composition, preferably from 300 to 450 g/L of the final composition, in a composition containing 1 to 900 g/L of tralomethrin, preferably from 1 to 144 g/L of tralomethrin.

17. The compositions according to the previous claims are used in combination with pesticides; for example, a combination in the amounts of 0.1 to 900 g/L of the final composition, preferably from 30 to 45 g/L of the final composition, in a composition containing 1 to 900 g/L of tralomethrin, preferably from 1 to 15 g/L of tralomethrin.

18. The compositions according to the previous claims are used in combination with pesticides; for example, a combination in the amounts of 0.1 to 900 g/L of the final composition, preferably from 60 to 190 g/L of the final composition, in a composition containing 1 to 900 g/L of acrinathrin, preferably from 1 to 30 g/L of acrinathrin.

19. The compositions according to the previous claims are used in combination with pesticides; for example, a combination in the amounts of 0.1 to 900 g/L of the final composition, preferably from 30 to 45 g/L of the final composition, in a composition containing 0.1 to 900 g/L of cyfluthrin, preferably from 0.1 to 15 g/L of cyfluthrin.

20. The compositions according to the previous claims are used in combination with pesticides; for example, a combination in the amounts of 0.1 to 900 g/L of the final composition, preferably from 130 to 200 g/L of the final composition, in a composition containing 0.1 to 900 g/L of cypermethrin, preferably from 1 to 66 g/L of cypermethrin.

21. The compositions according to the previous claims are used in combination with pesticides; for example, a combination in the amounts of 0.1 to 900 g/L of the final composition, preferably from 300 to 500 g/L of the final composition, in a composition containing 0.1 to 900 g/L of permethrin, preferably from 1 to 160 g/L of permethrin.

22. The compositions according to the previous claims are used in combination with pesticides; for example, a combination in the amounts of 0.1 to 900 g/L of the substance of the invention, preferably from 300 to 500 g/L of the substance of the invention, in a composition containing 1 to 900 g/L of bifenthrin, preferably from 1 to 160 g/L of bifenthrin.

23. The compositions according to the previous claims are used in combination with pesticides; for example, a combination in the amounts of 0.1 to 900 g/L of the final composition, preferably from 15 to 30 g/L of the final composition, in a composition containing 0.1 to 500 g/L of pyrethrins (pyrethrum extract), preferably from 0.1 to 30 g/L of pyrethrins.

The compositions according to certain previous claims can be used against rice weevils (Sitophilus oryzae), which is a species of insects of the coleoptera order, the Curculionidae family, with a cosmopolitan distribution. This pest is thus named because the female lays her eggs in the grains of cereals, in particular rice, causing damage to stocks. It is classed by certain authors in the Curculionidae family or in the Dryophthoridae1 family. Sitotroga cerealella (Angoumois grain moth or rice grain moth) is an insect species of the lepidoptera order (Tineidae family), with a cosmopolitan distribution. It is a pest that attacks the grains of cereals (corn, wheat, barley, rice, etc.), both in the wheat ears in the fields and in the storage facilities (granaries, silos, etc.). It is found in all temperate to warm regions around the world, counter Sitotroga The grain capuchin (Rhyzopertha dominica) is a species of insects of the coleoptera order, with a cosmopolitan distribution. It belongs to the monotypic Rhyzopertha genus.

It is an important pest of stored grain, against flying insects, such as flies and mosquitoes, and crawling insects, such as cockroaches, lice, fleas, and ants, as well as combating wood parasites.

The compositions according to the previous claim are also used to destroy the abovementioned flying or crawling insects as a spatial outdoor treatment for treating urban spaces, as well as a spatial treatment inside buildings or living areas.

The compositions according to any one of the previous claims are used to combat bedbugs, fleas, lice, ticks and acarids; ectoparasites that live on the human body, in bedding and in clothes. There are numerous species of fleas, lice, ticks and hematophagous acarids. Lice are human parasites that live on their bodies or clothes, while bedbugs are often found feeding on the blood of humans or pets. Bedbugs, which are also found in other furniture, feed off blood they collect by biting humans. Certain acarids, for instance the scabies mite, are skin parasites, the prevention of infestation by fleas (Ctenocephalides canis and against Ctenocephalides felis); for instance, a combination in the amounts of 0.1 to 900 g/L of the final composition, preferably 100 g/L of the final composition, in a composition containing 0.1 to 900 g/L of permethrin, preferably from 15 g/L of permethrin.

24. The compositions of the invention are characterized in that they can contain 0.1 to 25 g/L of deltamethrin, preferably from 5 to 15 g/L of deltamethrin.

28. The compositions of the invention are characterized in that they can contain 0.1 to 155 g/L of tralomethrin, preferably from 100 to 155 g/L of tralomethrin.

25. The compositions of the invention are characterized in that they can contain 0.1 to 20 g/L of cyhalothrin, preferably from 10 to 15 g/L of cyhalothrin.

26. The compositions of the invention are characterized in that they can contain 0.1 to 35 g/L of acrinathrin, preferably from 20 to 30 g/L of acrinathrin.

27. The compositions of the invention are characterized in that they contain 1 to 25 g/L of cyfluthrin, preferably from 15 to 20 g/L of cyfluthrin.

28. The compositions of the invention are characterized in that they contain 1 to 75 g/L of cypermethrin, preferably from 10 to 70 g/L of cypermethrin.

29. The compositions of the invention are characterized in that they contain 1 to 200 g/L of bifenthrin, preferably from 100 to 160 g/L of bifenthrin.

30. The compositions of the invention are characterized in that they contain 1 to 200 g/L of permethrin, preferably from 100 to 160 g/L of permethrin.

31. The compositions of the invention are characterized in that they contain 0.1 to 200 g/L of tefluthrin. This composition is intended to be used in the fight against, among others, the 3 main burrowing pests of cereals, which are beetles, zabrus, and flesh flies. This composition features a very high vapor pressure, which provides it with an extended action persistence compared with other molecules, for optimal effectiveness until the end of winter.

### BRIEF DESCRIPTION OF THE FIGURES

FIG. 1: Structure of papain, a cysteine protease.

FIG. 2: Model by Sierbert et al. 1996. In this model, the polyphenols can bind the proteins by both ends and the proteins have a limited number of binding sites. Three types of interaction are described based on the phenol/protein ratio; A: at equal ratio, a maximum network is observed; B: in protein excess,

the phenols can only bind 2 proteins. C: in phenol excess, all the sites of the protein are saturated in phenol and the bridging of two proteins is made more difficult. Adapted from Sierbert et al. 1996 [124].

FIG. 3: The production of esterases by sensitive mosquitoes is very low, and insufficient to prevent the insecticide from working. In certain resistant strains, the production of esterases in far greater quantities is the mechanism that is behind their resistance. It is therefore not a qualitative change (esterase efficiency), but a quantitative change (the increase in the quantity of esterases produced can be considerable, even representing 6 to 10% of the insect's total proteins).

FIG. 4: Sensitive mosquito

FIG. 5: Resistant mosquito

FIG. 6: Observations: Sensitive subjects The production of esterases by sensitive mosquitoes is reduced and insufficient to prevent the Propoxur insecticide (Baygon) from working. Resistant subjects Observations: the analysis of results for resistant mosquitoes: the slope of the curves showing the evolution of the optical density is almost the same in the wells with or without insecticide. It is therefore possible to conclude that the ACE of resistant mosquitoes is completely resistant to the Propoxur (Baygon) insecticide.

FIG. 7: Observations: The analysis of results for resistant and sensitive mosquitoes: with respect to the control wells (A), the evolution of the optical density of the wells wherein the insecticide (B) NILO-PYR was added is close to nil (horizontal line). The ACE has therefore been inactivated by the NILO-PYR insecticide.

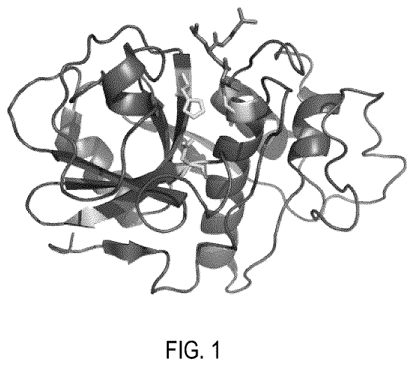

### DETAILED DESCRIPTION OF THE INVENTION

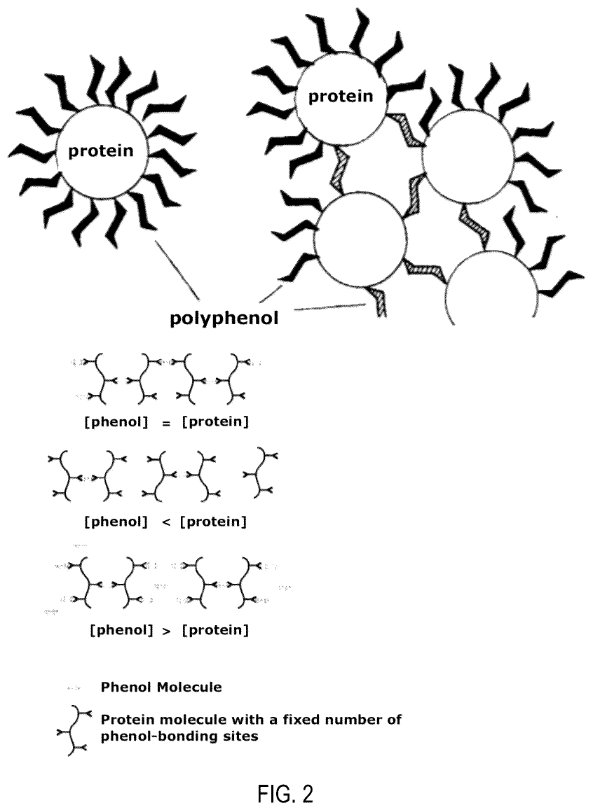

The present invention refers to the model proposed by Siebert et al. in 1996 after studies of the interactions between catechin and tannic acid on several peptides (gelatin, gliadin, lysozyme, papain, or synthetic polypeptide), using light diffusion studies. It is a binding mechanism based again on hydrophobic interactions. On one hand, nonpolar amino acids can hinder the formation of complexes by favoring the folding of hydrophobic regions of the molecule inwards, making them inaccessible. Alternatively, the same amino acids can favor the formation of complexes, if they act by cooperating with an adjacent proline residue to increase the activity of the binding site. Other amino acids can have a steric or electrostatic effect on the complexation [124]. In this instance, the system takes into account the tannin-protein ratios (FIG. 2).

Indeed, according to Sierbert et al. Each protein features a fixed number of sites for binding with the tannins, and the tannins have two (or more) ends that can bind to the proteins. Thus, at an equal concentration in tannins and proteins, a maximum network is observed, corresponding to an excess in large protein colloids. Polyphenols can only bind two proteins and form smaller particles. And in tannin excess, all of the sites of the protein are saturated by the tannins. Access to a tannin that is already bonded to a protein at the site of another protein is therefore more difficult, making the bridging impossible. This results in the formation of smaller particles.

In mosquitoes, there are two types of esterases, named A and B. (The esterases (A) preferentially use alpha NA, and the esterases B preferentially act on beta NA). This action enables to prevent the insecticide from penetrating and circulating in the organism of the insect, and therefore from reaching its target. It is a detoxification mechanism that relies on metabolizing the insecticide.

Identification of increased esterase production in resistant mosquitoes: The quantity of esterases produced by one mosquito can be assessed by the filter paper test. Principle of the experimental protocol applied to the population of mosquitoes of the Montpellier region (including resistant mosquitoes and mosquitoes that are sensitive to insecticides): the collected mosquitoes are crushed and placed on a filter paper, then the following reagents are added:
a mixture of the two substrates on which the esterase acts by cutting them,
a reagent that colors one of the obtained products red.

The results obtained are presented in the appended document (each box corresponds to one mosquito).

### Laboratory Testing.

The chromogenic substrate is a mixture of alpha-naphthyl acetate (alpha NA) and of beta-naphthyl acetate (beta NA). If absolutely necessary, only one of the 2 can be used, but usually, a mixture of the two in a 1:1 ratio is required.

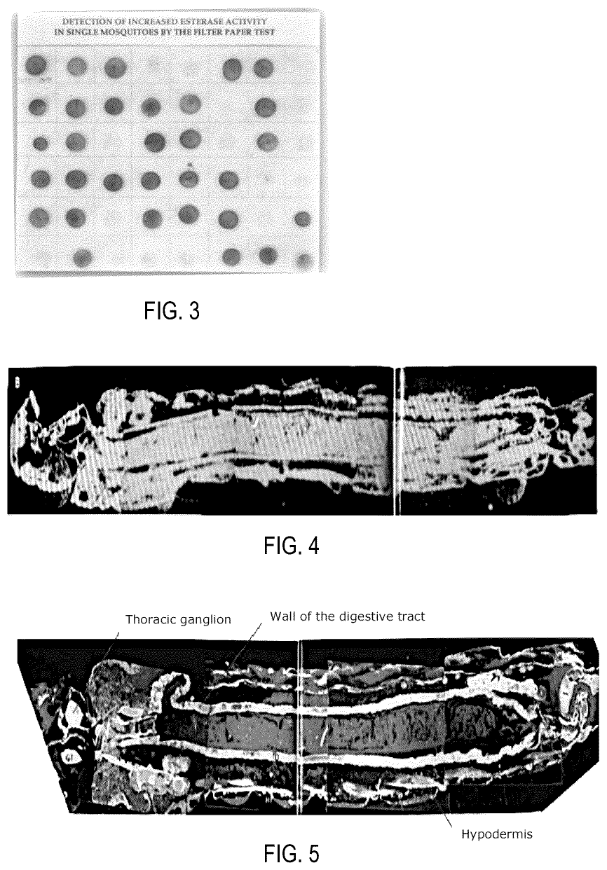

The esterase cuts the two substrates, releasing alpha (or beta) naphthol, which colors in the presence of Fast Garnet GBC (powder added in the coloration buffer). The product added to Fast Garnet generates a red precipitate, which provides the color on the filter paper. When the mosquito is crushed on the paper, revelation takes between 5 and 15 minutes, if all the reagents are ready. The esterases (A) preferentially use alpha NA, and the esterases (B) preferentially act on beta NA.
DETECTION OF INCREASED ESTERASE ACTIVITY IN THE MOSQUITO BY A FILTER PAPER TEST (FIG. 3).

The production of esterases in mosquitoes The esterases can be identified by an immunofluorescence technique (FIGS. 4-5).

Identification of esterase B1 by immunofluorescence in a mosquito sensitive to organophosphate insecticides and in a resistant mosquito. The intensity of the basic fluorescence translates into a blue color, a higher fluorescence translates into a color that ranges from yellow to red, depending on its increasing intensity. (La Recherche, n° 234, July/August 1991).

The genes that code for esterases are not expressed in all of the insect's tissues; this expression occurs mainly in the wall of the digestive tract, the sub-hypodermic cutaneous cellular zone and the cerebral and thoracic ganglia, the first two tissues constituting the main penetration paths of the insecticide into the organism, the last containing the target of the insecticides.

The mechanisms that render the target less sensitive to the insecticide: the mutations of the acetylcholinesterase (ACE) Certain mosquitoes owe their resistance to organophosphate insecticides and to carbamates to a change in the spatial structure of their ACE molecules, the target of the insecticides, a change renders the ACE insensitive to the action of insecticides.

The compositions of the invention are characterized in that they prevent the esterases produced by the mosquitoes from trapping or metabolizing the insecticides before they are able to inhibit the acetylcholinesterase (ACE) in the synapses.

The compositions of the invention enable the insecticide to penetrate the organism of the resistant mosquito and to circulate within its internal environment, to cause its nervous system to malfunction, and to act on the target, the acetylcholinesterase enzyme (ACE, present at the level of the cholinergic synapses and responsible for hydrolyzing the acetylcholine neurotransmitter).

One of the sources of the emergence of resistance is associated with an overproduction of detoxifying enzymes by certain insects. By halting this overproduction, the present invention enables limiting multiplication of these resistant strains.

One of the special properties of the present invention is that it inhibits the enzyme produced by the insect, and therefore prevents the substrate from binding to the active site of the insecticide by binding in its place, or provoking a deformation of the enzyme that renders it inactive. This composition is also antioxidant, and it intervenes at the initiation stage. In vivo, the oxygenases (enzymes that enable oxidation), such as lipoxygenase and cyclooxygenase enable the synthesis of eicosanoids, leukotrienes for the first, prostaglandins for the second, from arachidonic acid C(20:4) and C(18:3).

The compositions of the invention contain, among the amino acids, a catalytic triad (at least three catalytic residues), containing a serin (0.1 to 4.8 g/L), a histidine (0.1 to 1.5 g/L) and an aspartic acid (0.5 to 22.9 g/L), a glutamic acid (0.1 to 10 g/L), which is important for the hydrolysis of the biodegradation enzymes produced by the insects.

The compositions of the invention are characterized by the formation of a covalent bond between the biodegradation enzyme produced by the insects and the inhibitor according to the reactive mechanism: The synergist substance features a composition of fatty, saturated, monounsaturated, polyunsaturated acids, chosen from among long-chain fatty acids, C(6:O), C(8:O), C(10:O), C(12:O), C(14:O), medium-chain fatty acids, C(16:Ow9), C(17:O), C(18:O), C(18:1w9), C(18:1w7), (C18:2LA), C(18:3) and long-chain fatty acids, C(20:0), C(20:1w11), (C20:1w9), C(20:4), C(24:O), that cause in synergy the nervous system of insects to malfunction, and to act on the target, the acetylcholinesterase enzyme (ACE, present at the level of the cholinergic synapses and responsible for hydrolyzing the acetylcholine neurotransmitter).

The present invention acts against the tolerance phenomena of these pests (insects) and in particular mosquitoes resistant to pyrethroids by its action associated with the presence of long-chain fatty acids, among which feature two isomers such as: C(20:1w11), C(20:1w9). The action they generate accelerates the speed of action of the insecticide by rapidly reaching the target, in this case the synaptic space. It must therefore rapidly penetrate the organism of the insect and circulate within its internal environment. The compositions of the invention are characterized by the action of preventing the esterases produced by the mosquitoes from trapping or metabolizing the insecticides, before they are able to inhibit the acetylcholinesterase (ACE) in the synapses.

The compositions of the invention relate to a new pesticide synergist composition containing as active ingredient a cysteine proteolytic enzyme or a mixture of cysteine proteolytic enzymes, among which are papain associated with a composition of fatty, saturated, monounsaturated, polyunsaturated acids which can be chosen from among short-chain fatty acids: C(6:O), C(8:O), C(10:O), C(12:O), C(14:O), medium-chain fatty acids, C(16:0 w9), C(17:O), C(18:O), C(18:1w9), C(18:1w7), (C18:2LA), C(18:3) and long-chain fatty acids, C(20:0), C(20:1w11), (C20:1w9), C(20:4), C(24:O).

The differences in the properties of the ACE (acetylcholinesterase) between mosquitoes that have this form of resistance and sensitive mosquitoes can be detected using the following test:
Experimental protocol TESTS No.-1: Sensitive and resistant mosquitoes. Tested product: the Propoxur insecticide (Baygon).
Experimental protocol TESTS No.-2: Sensitive and resistant mosquitoes. Tested product: -NILO-PYR insecticide, the composition of which contains: 2.5 g/L of pyrethrins and 12.5 g/L of the “SYNERGIST OF THE COMPOSITION OF THE PRESENT INVENTION-SX-PYR”.

1° the mosquito (or larva) is crushed and the crushed material is homogenized in an Eppendorf tube with a buffer solution (20 mM tris, pH 7, containing 1% of Triton X-100). After centrifugation at 10,000 g for 2 minutes, the supernatant (which contains the ACE) is collected and distributed in the wells (A) and (B) of a microplate (100 microliters in each well),

2° in each well is then added either 10 microliters of a concentrated solution of insecticide (products containing pyrethrum at 10-2 M), Baygon, a brand of pesticides produced by S. C. Johnson well (B), and 10 microliters of alcohol, well (A). The microplate is left for 15 min at ambient temperature (which is sufficient to allow the action, if any, of the insecticide),

3°determination of the catalytic activity of the ACE (acetylcholinesterase): in each well is added 100 microliters of a solution containing acetylcholine (2.5 mM) and 0.2 mM of DTNB (dinitro-2-benzoic). The intensity of the coloration is assessed by measuring the optical density (the optical density increases based on the coloration). If the enzyme is active, the products of the hydrolysis of the acetylcholine react with the DTNB to produce a substance that features an absorption peak for radiations of 412 nm. It is therefore possible to follow the reaction by spectrophotometry.

### Experimental Protocol TESTS No.-1: Sensitive and Resistant Mosquitoes TEST Product: The Propoxur Insecticide (Baygon).

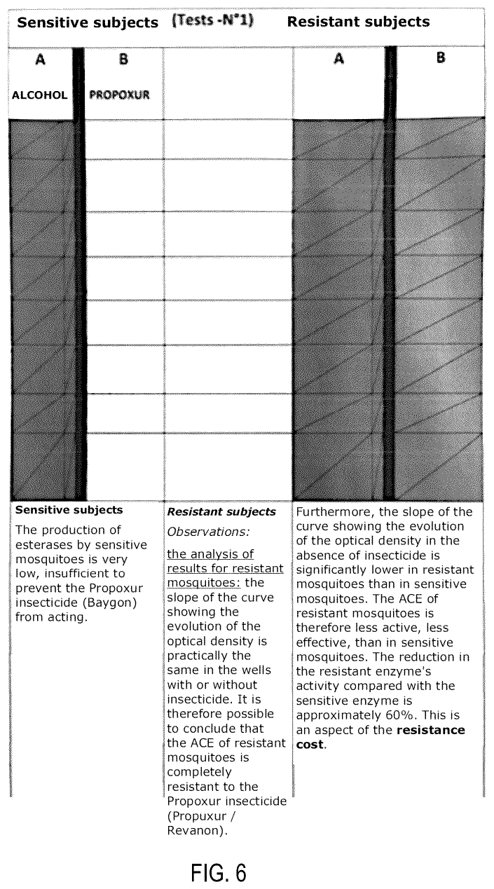

The below graphs show the evolution of the optical density over 10 min in each well, for 8 sensitive mosquitoes and 8 resistant mosquitoes (on y-axis: intensity of the optical density; x-axis: time). Furthermore, the slope of the curve showing the evolution of the optical density in the absence of insecticide is significantly lower in resistant mosquitoes than in sensitive mosquitoes. The ACE of resistant mosquitoes is therefore less active and less effective than that of sensitive mosquitoes. The reduction in the resistant enzyme's activity compared with the sensitive enzyme is approximately 60%. It is an aspect of the resistance cost (FIG. 6).

Experimental Protocol TESTS No.-2: Sensitive and Resistant Mosquitoes TESTED Product -NILO-PYR, the Composition of which Contains: 2.5 g/L of Pyrethrins and 12.5 g/L of the “SYNERGIST OF THE PRESENT INVENTION-SX-PYR”.

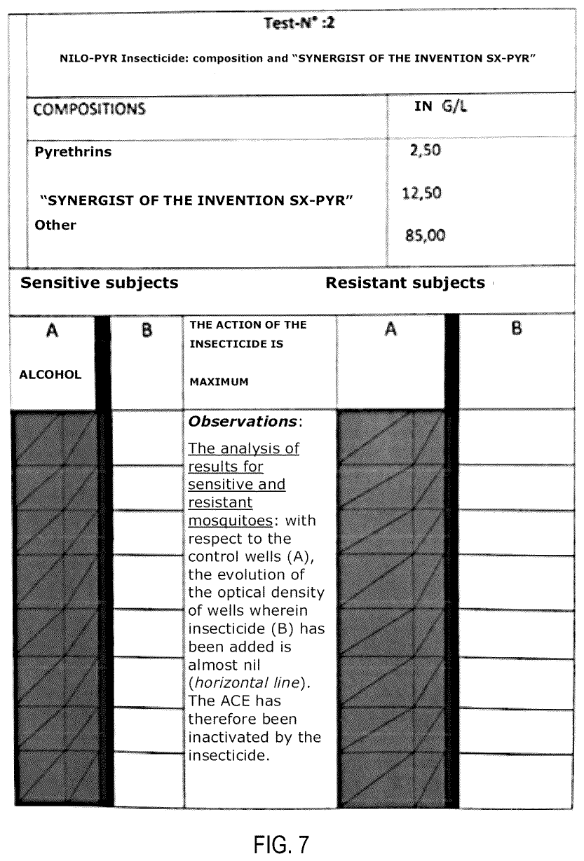

The compositions of this invention enable inhibition of the overproduction of detoxifying enzymes produced by resistant mosquitoes. (Illustration above-Test No.2 FIG. 7)

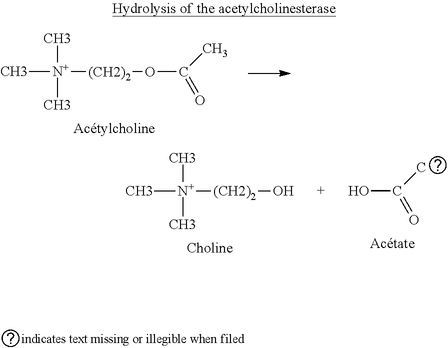

The present invention is characterized by its ability to provoke, at very low doses, the dissociation of a significant quantity of esterases produced by the insects, and more particularly by resistant mosquitoes.

The compositions of the present invention disrupt the increased production of esterases in resistant insects and makes the target of the acetylcholinesterase (ACE) more sensitive to the insecticide. The esterases are enzymes naturally produced by insects: they hydrolyze the ester bonds, in particular those of the molecules of organophosphate insecticides.

The compositions of the invention are characterized in that they prevent the esterases produced by the mosquitoes from trapping or metabolizing the insecticides before they are able to inhibit the acetylcholinesterase (ACE) in the synapses.

The compositions of the invention enable the insecticide to penetrate the organism of the resistant mosquito and circulate within its environment, to cause its nervous system to malfunction, and to act on the target, the acetylcholinesterase enzyme (ACE, present at the level of the cholinergic synapses and responsible for hydrolyzing the acetylcholine neurotransmitter).

One of the sources of the emergence of resistance is associated with an overproduction of detoxifying enzymes by certain insects. By halting this overproduction, the present invention enables inhibition of the multiplication of these resistant strains.

One of the special properties of the present invention is that it inhibits the enzyme produced by the insect, and therefore, prevents the substrate from binding to the active site of the insecticide by binding in its place, or provoking a deformation of the enzyme that renders it inactive.

The compositions of the invention contain, among the amino acids, a catalytic triad (at least three catalytic residues), containing a serin (0.1 to 4.8 g/L), a histidine (0.1 to 1.5 g/L) and an aspartic acid (0.5 to 22.9 g/L), a glutamic acid (0.1 to 10 g/L), which is important for the hydrolysis of the biodegradation enzymes produced by the insects.

The compositions of the invention are characterized by the formation of a covalent bond between the biodegradation enzyme produced by the insects and the inhibitor according to the reactive mechanism:

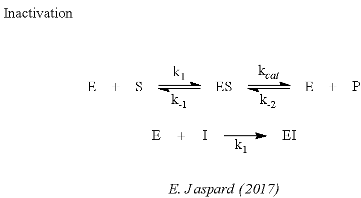

The compositions of the invention can contain one or several proteolytic enzymes (bromelain, ficin). In addition to traditional proteases (fig tree ficin, papaya papain, pineapple bromelain), can be mentioned asclepainc (Iselcpius speciosa), euphorhaine (E. cernera), sufanahie (S. eleagnifouliutri), pontirite (Ilaclura pam(fera) and mexicautc (1Meus mexicattus).

The compositions of the invention relate to a pesticide synergist composition containing as active ingredient a cysteine proteolytic enzyme or a mixture of cysteine proteolytic enzymes, which can include papain.

The compositions of the invention relate more particularly to a new composition of a synergist of pesticides, characterized in that it contains a cysteine protease of formula (I), or a mixture of compounds of formula (I).

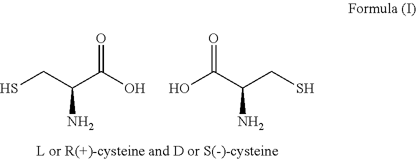 [SMILES: N[C@@H](CS)C(=O)O ; N[C@H](CS)C(=O)O]

The first step of the reaction mechanism catalyzed by the cysteine proteases is the deprotonation of the thiol group, carried by the residue of cysteine of the active site, by the basic lateral chain of a neighboring amino acid, generally a residue of histidine. The next step is the nucleophile attack of the atom of carbon constituting the carbonyl of the substrate by the sulfur anion of the deprotonated cysteine. The N-terminal fragment of the substrate is then released, while the histidine residue returns to its deprotonated state and an intermediary between the enzyme and the rest of the substrate is formed by covalence through a thioester bond. This thioester bond is then hydrolyzed, which releases both the C-terminal fragment of the substrate and the enzyme regenerated in its active form.

In very recent work, CAREY (51 bis) proved, using resonance Raman spectroscopy, that the active site of the papain reorganizes after a certain period of time following its action on a protein substrate; recent work on soybean proteins, a high-value food product, shows us that papain can act on the behavior of these foodstuffs, by increasing the proportion of free amine groups; gelation is prevented, but, however, the stability of the emulsion is reduced; the enzymatic action should therefore be controlled.

The present invention is characterized by one of the compositions that enable quick penetration of the insecticide in the nervous system of pests, owing to the simultaneous presence of short-chain fatty acids, which include a combination of fatty acids such as: C(6:6), C(8:O), C(10:O), C(12:O), C(14:O).

This composition is also antioxidant, and it intervenes at the initiation stage. In vivo, the oxygenases (enzymes that enable oxidation), such as lipoxygenase and cyclooxygenase enable the synthesis of eicosanoids, leukotrienes for the first, prostaglandins for the second, from arachidonic acid C(20:4) and C(18:3).

The synergist of the present invention intervenes in the process of combating the detoxification of pyrethrins and pyrethroids (I) and (II) by the insects.

Mosquitoes and pests that harm crops and are resistant to insecticides participate in an increased production of detoxification enzymes: “The esterases are enzymes naturally produced by all mosquitoes: they degrade organophosphorus insecticides; they are biodegradation enzymes”. The insects generally produce proteins that enable inactivation of toxic substances, even after a treatment, and presumed-dead insects are sometimes reanimated by their enzymes that continue to detoxify the ingested insecticides.

The present invention is also characterized by its antioxidant role with respect to insecticides, thereby prolonging the remanence of pyrethrins and pyrethroids (I) and (II) by the action of one of its medium-chain fatty acid components, which include, for instance, C(16:1w9), C(16:1cisw7).

The compositions of the invention contain one or several polyphenolic compounds composed of hydrolysable tannins (gallic or ellagic tannins) or flavonoids, such as flavanols, for instance quercetin.

The compositions of the invention may contain one or several triglycerides, which include (sesame, cotton, coconut, paraffin, sunflower, soybean, canola or corn oil, preferably methylated sesame, cotton or canola oil.

The compositions of the invention may contain one or several pyrethroids as well as other insecticidal products, such as organophosphates, organochlorines, carbamates, as well as other acaracidal, fungicidal, and herbicidal products.

The present invention relates to a synergist composition of pesticides among insecticides, it can contain the pyrethroids (I) and (II), such as: permethrin, bifenthrin, deltamethrin, tetramethrin, cypermethrin, and different mixtures of isomers derived therefrom, and in particular α-cypermethrin and asymethrin, esbiothrin, kadethrin, acrinathrin, cyhalothrin, and the different mixtures of isomers derived therefrom, and in particular λ-cyhalothrin, cyfluthrin, tralomethrin, fluvalinate, fenvalerate, s-fenvalerate, or (1R,cis) 2,2-dimethyl 3-[(Z) 2-(methoxycarbonyl) ethynyl] cyclopropane carboxylate of (S) α-cyano 3-phenoxybenzyle.

The compositions of the invention can also contain a phase change inhibitor chosen from among ethanol, isopropyl alcohol, benzyl alcohol and the mixture thereof, or (+)-4-Isopropenyl-1-methylcyclohexene, (+)-Isopropenyl-4 methyl-1 cyclohexene, D-Isopropenyl-4 methyl-1 cyclohexene, (D)-limonene.

The present invention generates human health benefits through formulations with a lower active ingredient concentration, and therefore more favorable toxicological ratings.

The compositions of the present invention associated with pesticides considerably reduce the quantity of insecticides necessary and enable the levels of insecticide residues to be reduced, for example, in stored grains that have been treated with the insecticides.

The compositions of the invention offer the possibility of managing the resistance of insects to organophosphate insecticides and carbamates and could, at the level of the WHO, form part of the resistance management program, centered on the mosquito C. pipiens, and in particular on vectors of endemic diseases, such as the Anopheles.

The compositions of the invention are characterized in that they are environmentally friendly by reducing the quantity of insecticides in biocidal formulations by 30 to 40%, they reduce the risk of transfer of significant quantities of insecticide residues into the environment.

The invention relates more specifically to a synergist of pesticides that is less harmful to humans and the environment; according to the following toxicological and ecotoxicological information: Acute toxicity (oral): Not classified. Acute toxicity (skin): Not classified. Acute toxicity (inhalation): Not classified. Skin corrosion/skin irritation: Not classified. Additional information: Based on the available data, the classification criteria have not been met. Mutagenicity on germ cells: Not classified. Additional information: Based on the available data, the classification criteria have not been met. Carcinogenicity: Not classified. Additional information: Based on the available data, the classification criteria have not been met. Reproductive Toxicity: Not classified. Additional information: Based on the available data, the classification criteria have not been met. Specific target organ toxicity (single exposure): Not classified.

Additional information: Based on the available data, the classification criteria have not been met. Specific target organ toxicity

(Repeated exposure): Not classified. Additional information: Based on the available data, the classification criteria have not been met. Aspiration hazard: Not classified. Acute aquatic toxicity: Not classified. Chronic aquatic toxicity: Not classified. Acute aquatic toxicity: Not classified. Chronic aquatic toxicity: Not classified. Persistence and degradability: Not established. Bioaccumulation potential: Not established. Mobility in soil: No additional information available.

The invention relates more specifically to the compositions in the form of emulsifiable concentrates, or dilutable concentrates.

The compositions of the invention may mostly contain pesticides, but are naturally of greater use as a synergist of the pyrethroids (I) and (II), and the pyrethrins that degrade rapidly under the effect of light and heat.

The present invention relates more specifically to a synergist composition of pesticides containing, as active ingredients, a cysteine proteolytic enzyme, or a mixture of cysteine proteolytic enzymes, preferably papain, and a polyphenolic compound from among hydrolysable tannins (or gallic or ellagic tannins), such as tannic acid, and from among triglycerides, such as sesame oil, a phase change inhibitor, such as ethanol, and from among organic peroxides preferably hydrogen peroxide; said composition is intended for use and for managing the resistance associated with the mechanism of insects whereby they detoxify insecticides and for improving the efficiency of certain insecticides, such as (natural pyrethrum and pyrethroids (I) and (II)).

The present invention relates to compositions containing pyrethrins and pyrethroids (I) and (II), and a mixture thereof.

The present invention relates to compositions containing pyrethrum flower extract, of which the active ingredients are pyrethroids (I) and (II).

The present invention relates specifically to compositions that contain pyrethroids (I) and (II), such as: permethrin, bifenthrin, deltamethrin, tetramethrin, cypermethrin, and different mixtures of isomers derived therefrom, in particular α-cypermethrin, asymethrin, esbiothrin, kadethrin, acrinathrin, cyhalothrin, and the different mixtures of isomers derived therefrom, and in particular λ-cyhalothrin, cyfluthrin, tralomethrin, fluvalinate, fenvalerate, s-fenvalerate, or (1R,cis) 2,2-dimethyl 3-[(Z) 2-(methoxycarbonyl) ethynyl] cyclopropane carboxylate of (S) α-cyano 3-phenoxybenzyle.

The invention more specifically relates to the compositions characterized in that they contain 0.1 to 500 g/L of papain.

The compositions of the invention include compositions containing from 1 to 100 g/L of tannic acid.

The invention specifically relates to a pesticide synergist composition characterized in that it contains 5 to 800 g/L of sesame oil and 300 to 700 g/L of a phase change inhibitor chosen from among ethanol, isopropyl alcohol, benzylic alcohol, and the mixture thereof.

Preferred compositions of the invention include compositions characterized in that they contain 1 to 25 g/L of papain, 1 to 350 g/L of hydrogen peroxide, 1 to 700 g/L (of ethanol, isopropyl alcohol, benzylic alcohol, and the mixture thereof). The latter include those that further contain 1 to 400 g/L of coco glucoside.

Example of compositions of the invention. EXAMPLE 1: The following compositions have been prepared, containing:

| RAW MATERIALS | IN G/L |
|---|---|
| Papain | 1 to 100.00 |
| Tannic acid | 1 to 100.00 |
| Sesame oil | 1 to 250.00 |
| Hydrogen peroxide | 1 to 350.00 |
| Ethanol, isopropyl alcohol, benzylic | 1 to 500.00 |
| alcohol, and/or the mixture thereof) | |
| Coco glucoside | 1 to 100.00 |
| Acetic acid and/or citric acid | 0.1 to 10.00 |

Compositions similar to that of example (1) were prepared, wherein 1 to 250 g/L of sesame oil were replaced by 1 to 250 g (of coconut oil or coconut butter), 1 to 250 g of white paraffin, 1 to 250 g of canola oil, 1 to 250 g of soybean oil, 1 to 250 g of sunflower oil, or 1 to 250 g of methylated canola oil, and the present compositions can further contain 0.1 to 10 g/L of citric acid, and 0.1 to 10 g/L of acetic acid.

Compositions similar to that of the example (1) were prepared, wherein 0.1 to 250 g/L of fatty acids, C(6:O), C(8:O), C(10:O), C(12:O), C(14:O), medium-chain fatty acids, C(16:Ow9), C(17:O), C(18:O), C(18:1w9), C(18:1w7), C(18:2LA), C(18:3) and long-chain fatty acids, C(20:0), C(20:1w11), C(20:1w9), C(24:O), C(24:O), associated with 0.1 to 100 g of tannic acid and 1 to 250 g of (+)-4-Isopropenyl-1-methylcyclohexene, (+)-Isopropenyl-4 methyl-1 cyclohexene, D-Isopropenyl-4 methyl-1 cyclohexene, (D)-Limonene and, in addition, the present compositions can contain 0.1 to 10 g/L of citric acid, and 0.1 to 10 g/L of acetic acid.

Example of compositions of the invention. EXAMPLE 2: Compositions were prepared containing:

| RAW MATERIALS | IN G/L |
|---|---|
| PAPAIN | 1 to 100.00 |
| TANNIC ACID | 1 to 100.00 |
| SESAME OIL | 1 to 250.00 |
| MEULALEUCA ALTENIFOLIA AND/OR | 1 to 50.00 |
| QUINQUINEVARIA ESSENTIAL OIL | |
| HYDROGEN PEROXIDE | 1 to 500.00 |
| ETHANOL | 1 to 500.00 |
| COCO GLUCOSIDE | 1 to 400.00 |
| CITRIC ACID | 0.1 to 10.00 |

Compositions similar to that of the example (2) were prepared, wherein 1 to 250 g/L of sesame oil were replaced by 1 to 250 g (of coconut oil or coconut butter), 1 to 250 g of white paraffin, 1 to 250 g of canola oil, 1 to 250 g of soybean oil, 1 to 250 g of sunflower oil, or 1 to 250 g of methylated canola oil, 1 to 500 g/L (of isopropyl alcohol, benzylic alcohol, or a mixture thereof).

The above compositions are used in combination with pesticides; examples include a combination in the amounts of 1 to 900 g/L of the composition of the invention, preferably from 30 to 45 g/L of the composition, in a composition containing 1 to 900 g/L of deltamethrin, preferably 1 to 15 g/L of deltamethrin, more specifically 45 g/L of the composition of the invention in a composition containing 15 g/L of deltamethrin.

The above compositions are used diluted and are applied using a sprayer; it is, for example, possible to dilute 100 ml of this composition in 5 liters of water. It is therefore possible to effectively treat 100 m2 of surface area (treatment against crawling insects). When treating surface areas against flying insects, 65 ml of the composition described above can be diluted in 5 liters of water. When treatments via nebulization are required, it is possible to dilute 700 ml of the above compositions in 9 liters of a petroleum solvent and apply the obtained solution in the amount of 500 ml of solution per hectare. When indoor spaces are to be treated, it is possible to dilute 500 ml to 1000 ml of the composition described above in 4 liters of a petroleum solvent and apply 250 ml of the obtained solution to treat 1000 m3 of indoor space.

The above compositions are used in combination with pesticides; for example, a combination in the amounts of 1 to 900 g/L of the composition of the invention, preferably from 300 to 450 g/L of the composition of the invention, in a composition containing 1 to 900 g/L of tralomethrin, preferably from 1 to 144 g/L of tralomethrin.

The above compositions are used in combination with pesticides; for example, a combination in the amounts of 1 to 900 g/L of the composition of the invention, preferably from 30 to 45 g/L of the composition of the invention, in a composition containing 1 to 900 g/L of tralomethrin, preferably from 1 to 15 g/L of tralomethrin.

The above compositions are used in combination with pesticides; for example, a combination in the amounts of 1 to 900 g/L of the composition of the invention, preferably from 60 to 190 g/L of the composition of the invention, in a composition containing 1 to 900 g/L of acrinathrin, preferably from 1 to 30 g/L of acrinathrin.

The above compositions are used in combination with pesticides; for example, a combination in the amounts of 1 to 900 g/L of the composition of the invention, preferably from 30 to 45 g/L of the composition of the invention, in a composition containing 1 to 900 g/L of cyfluthrin, preferably from 1 to 15 g/L of cyfluthrin.

The above compositions are used in combination with pesticides; for example, a combination in the amounts of 1 to 900 g/L of the composition of the invention, preferably from 130 to 200 g/L of the composition of the invention, in a composition containing 1 to 900 g/L of cypermethrin, preferably from 1 to 66 g/L of cypermethrin.

The above compositions are used in combination with pesticides; for example, a combination in the amounts of 1 to 900 g/L of the composition of the invention, preferably from 300 to 500 g/L of the composition of the invention, in a composition containing 1 to 900 g/L of permethrin, preferably 480 g/L of the composition of the invention in a composition containing 160 g/L of permethrin.

The compositions [0066 above] are intended to combat bedbugs, fleas, lice, ticks and acarids; ectoparasites that live on the human body, in bedding and in clothes. There are numerous species of fleas, lice, ticks and hematophagous acarids. Lice are human parasites that live on their bodies or clothes, while bedbugs are often found feeding on the blood of humans or pets. Bedbugs, which are also found in other furniture, feed off blood they collect by biting humans. Certain acarids, for instance those that carry scabies, are skin parasites.

The substance of the invention is used in combination with pesticides for the treatment and prevention of flea infestations (Ctenocephalides canis, Ctenocephalides felis); such as, for example, a combination in the amounts of 1 to 900 g/L of the composition of the invention, preferably 100 g/L of the composition of the invention, in a composition containing 1 to 900 g/L of permethrin, preferably 15 g/L of permethrin, of 1 to 300 g/L of N-methyl pyrrolidone, from 1 to 200 g/L of Miglyol 812, from 1 to 70 g/L of citric acid.

The compositions of the invention are used for the treatment and prevention of flea infestations (Ctenocephalides canis, Ctenocephalides felis); they are recommended for use specifically against the target species, for example: Fleas present on a dog are killed within a day following treatment. A single treatment prevents reinfestations by fleas for four weeks. For the treatment of canine chewing louse (Trichodectes canis). The product has persistent acaricidal and repellent efficacy against tick infestations (Rhipicephalus sanguineus and Ixodes ricinus for four weeks, and Dermacentor reticulatus for three weeks). A single treatment provides repellent (anti-feeding) activity against sand flies

Phlebotomus papatasi for two weeks, and Phlebotomus perniciosus for three weeks), against mosquitoes (Aedes aegypti for two weeks and Culex pipiens for four weeks) and against stable flies (Stomoxys calcitrans) for four weeks.

The above compositions are used in combination with pesticides; for example, a combination in the amounts of 1 to 900 g/L of the composition of the invention, preferably from 300 to 500 g/L of the composition of the invention, in a composition containing 1 to 900 g/L of bifenthrin, preferably from 1 to 160 g/L of bifenthrin.

The above compositions are used in combination with pesticides; for example, a combination in the amounts of 1 to 900 g/L of the substance of the invention, preferably from 15 to 30 g/L of the composition of the invention, in a composition containing 1 to 900 g/L of pyrethrins (extract of pyrethrum flowers), preferably from 1 to 30 g/L of pyrethrins.

The compositions of the invention can be seen in the usual forms of the agrochemical industry or veterinarian industry when it involves increasing the efficiency of pesticides, and more specifically pyrethroids (I) and (II), intended to combat crop pests, such as aphids, and as insecticides against external parasites of animals, insects and acarids, using baths and sprays. They can also be used as shampoos, lotions and creams to combat lice in humans, for instance.

The compositions of the invention are characterized in that they can contain 1 to 25 g/L of deltamethrin, preferably from 5 to 15 g/L of deltamethrin.

The compositions of the invention are characterized in that they can contain 1 to 155 g/L of tralomethrin, preferably from 100 to 155 g/L of tralomethrin.

The compositions of the invention are characterized in that they can contain 1 to 20 g/L of cyhalothrin, preferably from 10 to 15 g/L of cyhalothrin.

The compositions of the invention are characterized in that they can contain 1 to 35 g/L of acrinathrin, preferably from 20 to 30 g/L of acrinathrin.

The compositions of the invention are characterized in that they can contain 1 to 25 g/L of cyfluthrin, preferably from 15 to 20 g/L of cyfluthrin.

The compositions of the invention are characterized in that they can contain 1 to 75 g/L of cypermethrin, preferably from 10 to 70 g/L of cypermethrin.

The compositions of the invention are characterized in that they can contain 1 to 200 g/L of bifenthrin, preferably from 100 to 160 g/L of bifenthrin.

The compositions of the invention are characterized in that they can contain 1 to 200 g/L of permethrin, preferably from 100 to 160 g/L of permethrin.

The compositions of the invention are characterized in that they can contain 90 to 250 g/L of cyclohexanone or another solvent of the ketone or glycol ether type, such as N-methyl pyrrolidone, N-amyl ketone or methyl ether of propylene glycol.

1-32. (canceled)

33. A synergist composition that is synergistic to pesticides selected from pyrethrins, type I pyrethroids, and type II pyrethroids, the composition comprising:
a fatty acid component comprising a saturated, monounsaturated and/or polyunsaturated fatty acid chosen from short-chain fatty acids, medium-chain fatty acids, and/or long-chain fatty acids, or combinations thereof, wherein:
the short-chain fatty acids are chosen from C(6:0), C(8:0), C(10:0), C(12:0), or C(14:0);
the medium-chain fatty acids are chosen from C(16:0w9), C(17:0), C(18:0), C(18:1w9), C(18:1w7), C(18:2LA), or C(18:3); and
the long-chain fatty acids are chosen from C(20:0), C(20:1w11), C(20:1w9) or C(24:0);
a cysteine protease; and
a polyphenolic composition comprising a polyphenolic compound or a mixture of the polyphenolic compounds, comprising:
hydrolysable tannins or gallic tannins or ellagic tannins; and/or
a flavonoid, a flavanol, or quercetin.

34. The synergist composition according to claim 33, wherein the cysteine protease is chosen from fig tree ficin, papaya papain, pineapple bromelain, protease from Asclepias, protease from Euphorbia, protease from solanine, protease from pomirin or protease from mexicain.

35. The synergist composition according to claim 34, wherein the cysteine protease is papaya papain.

36. The synergist composition according to claim 33, comprising from 1% to 90% by weight of the cysteine protease, based on the total weight of the synergist composition.

37. The synergist composition according to claim 33, wherein the polyphenolic compound is chosen from flavonoids, carnosic acid, carnosol, substituted (2,5-dihydroxyphenyl) carboxylic (2,5-dihydroxy phenyl) allylene carboxylic acids or derivatives thereof, esters or amides of caffeic acid, or tannic acid.

38. The synergist composition according to claim 33, wherein the polyphenolic compound is tannic acid.

39. The synergist composition according to claim 33, comprising from 1% to 10% by weight of the polyphenolic, based on the total weight of the composition.

40. The synergist composition according to claim 33, further comprising a triglyceride chosen from sesame oil, cotton oil, coconut oil, paraffin, sunflower oil, soybean oil, canola oil, corn oil, methylated sesame oil, methylated cotton oil, or methylated canola oil.

41. The synergist composition according to claim 40, wherein the triglyceride comprises sesame oil.

42. The synergist composition according to claim 33, comprising:
from 0.1 g/L to 800 g/L of the fatty acid component;
from 0.1 g to 100 g of tannic acid; and
from 1 g to 250 g of (+)-4-Isopropenyl-1-methylcyclohexene, (+)-Isopropenyl-4 methyl-1 cyclohexene, D-Isopropenyl-4 methyl-1 cyclohexene, and/or (D)-Limonene.

43. The synergist composition of claim 42, further comprising from 0.1 g/L to 10 g/L of citric acid, and/or 0.1 g/L to 10 g/L of acetic acid.

44. A pesticide composition comprising:
the synergist composition according to claim 33; and
at least one pyrethroid.

45. The pesticide composition according to claim 44, wherein the at least one pyrethroid is chosen from permethrin, bifenthrin, deltamethrin, tefluthrin, tetramethrin, cypermethrin, α-cypermethrin, asymethrin, esbiothrin, kadethrin, acrinathrin, cyhalothrin, λ-cyhalothrin, cyfluthrin, tralomethrin, fluvalinate, fenvalerate, s-fenvalerate, or (1R,cis) 2,2-dimethyl 3-[(Z) λ-(methoxycarbonyl) ethynyl] cyclopropane carboxylate of (S) α-cyano 3-phenoxybenzyle.

46. The pesticide composition according to claim 45, comprising:
from 0.1 g/L to 900 g/L of the synergist composition; and
from 1 g/L to 900 g/L of deltamethrin.

47. The pesticide composition according to claim 45, comprising:
from 0.1 g/L to 900 g/L of the synergist composition; and
from 1 g/L to 900 g/L of tralomethrin.

48. The pesticide composition according to claim 45, comprising:
from 0.1 to 900 g/L of the synergist composition; and
from 1 g/L to 900 g/L of acrinathrin.

49. The pesticide composition according to claim 45, comprising:
from 0.1 g/L to 900 g/L of the synergist composition; and
from 0.1 g/L to 900 g/L of cyfluthrin.

50. The pesticide composition according to claim 45, comprising:
from 0.1 g/L to 900 g/L of the synergist composition; and
from 0.1 g/L to 900 g/L of cypermethrin.

51. The pesticide composition according to claim 45, comprising:
from 0.1 g/L to 900 g/L of the synergist composition; and
from 0.1 g/L to 900 g/L of permethrin.

52. The pesticide composition according to claim 45, comprising:
from 0.1 g/L to 900 g/L of the synergist composition; and
from 1 g/L to 900 g/L of bifenthrin.
